(19) United States
(12) Patent Application Publication
(10) Pub. No.: US 2016/0188387 A1
(43) Pub. Date: Jun. 30, 2016

(54) MANAGEMENT OF DISPLAY OF COMPUTER POP-UP NOTIFICATIONS

(71) Applicant: FUTUREWEI TECHNOLOGIES, INC., Plano, TX (US)

(72) Inventor: Liangxin YANG, Shenzhen (CN)

(73) Assignee: FUTUREWEI TECHNOLOGIES, INC., Plano, TX (US)

(21) Appl. No.: 14/585,679

(22) Filed: Dec. 30, 2014

(51) Int. Cl. G06F 9/54; G06F 21/60; H04L 12/58

(52) U.S. Cl. CPC G06F 9/542; H04L 51/24; G06F 21/60

(57) ABSTRACT

A method performed by a computer for managing display of pop-up notifications when the displayed content of the computer is being shared. A notification request from an application running on the computer is received by the computer. The computer determines that displayed content of the computer is viewable for multiple users. Based upon the determining, the computer blocks display of the pop-up notification to prevent leaking of sensitive information to other users.

### FIELD OF THE INVENTION

This invention generally relates to pop-up notification management, and more specifically to protect users' privacy by managing display of pop-up notifications.

### BACKGROUND

Pop-up notifications, also called toastings, passive pop-ups, desktop notifications, notification bubbles, rustings, balloon notifications or simply notifications, are a way to communicate certain events to users of a graphical user interface without forcing them to react to this notification immediately. Desktop notifications usually disappear automatically after a short amount of time. Often their content is then stored and allows the users to access past notifications at a more convenient time.

Referring to FIG. 1, a conventional way to display pop-up notifications is described. Application programs 12 in an application layer 10 of a computer 1 may trigger a pop-up notification program 16 of an operating system 15 to generate a pop-up notification and consequently display the pop-up notification on a monitor 290. By using the pop-up notification function, pop-up notifications will be displayed without a user's active operation when an event occurs. For example, when an e-mail is received, a pop-up notification will be displayed on the monitor 290 with summarized information of the received e-mail. Since pop-up notifications may be displayed on the monitor 290 without the user's active operation, the pop-up notifications may cause a privacy problem—other people may learn the content of the pop-up notifications unintentionally, and sensitive information may be inadvertently disclosed to others.

### SUMMARY

A computer manages the display of pop-up notifications depending on whether its displayed content is being shared. A computer receives a notification request from an application running on the computer for causing display of a pop-up notification. The computer determines that displayed content of the computer is viewed by multiples users. As a response to the notification request, considering that the displayed content is viewed by multiple users, the computer blocks display of the pop-up notification.

The aforementioned method may be performed by a computer having one or more processors, memory and one or more modules, programs or sets of instructions stored in the memory for performing these methods.

Instructions for performing the aforementioned methods may be included in a computer program product configured for execution by one or more processors. In some embodiments, the executable computer program product includes a computer readable storage medium (e.g., one or more magnetic disk storage devices, flash memory devices, or other non-volatile solid state memory devices) and an executable computer program mechanism embedded therein.

### BRIEF DESCRIPTION OF THE DRAWINGS

FIG. 1 is a block diagram of a conventional computer for displaying pop-up notifications.

FIG. 2 is a block diagram of a computer suitable for use in embodiments of the invention.

FIG. 3 is a block diagram of a computer for managing display of pop-up notifications.

FIG. 4 is a block diagram of a computer connected to a projector.

FIG. 5 is a block diagram of a computer sharing its screen with another computer with a screen sharing software.

FIG. 6 is a block diagram illustrating multiple users viewing a monitor of a computer.

FIG. 7 is a flowchart of a method for managing display of pop-up notifications on a display during a shared session.

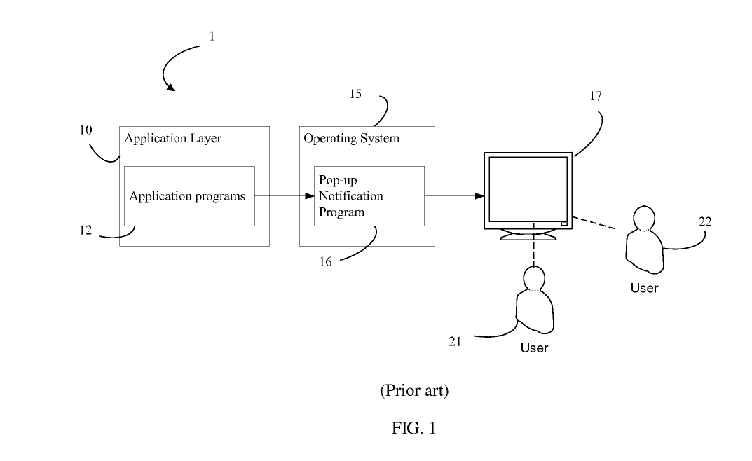

### DETAILED DESCRIPTION

Although the present invention has been described with reference to specific features and embodiments thereof, it should be understood that various changes and substitutions can be made thereto without departing from the spirit and scope of the present invention as defined by the following claims.

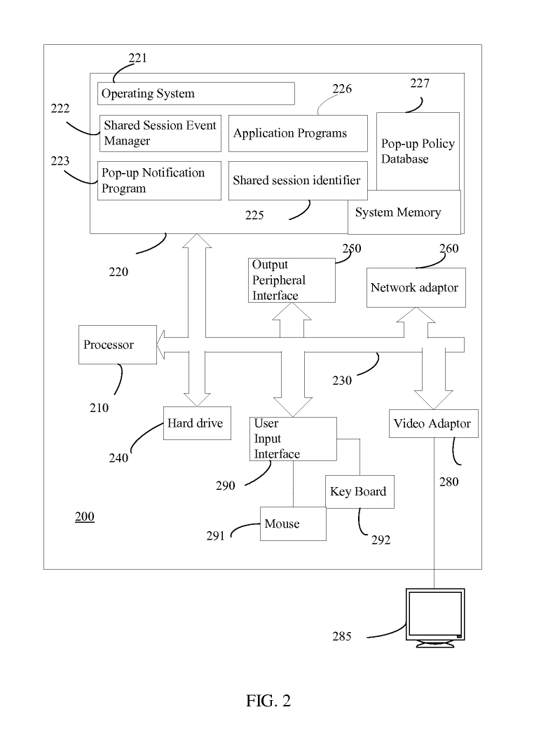

FIG. 2 illustrates an example of a suitable computing environment, a computer 200, on which the subsequently described methods and apparatuses may be implemented. The exemplary computer 200 is only one example of a suitable computing environment and is not intended to suggest any limitation as to the scope of use or functionality of the improved methods and systems described herein. Neither should the computer 200 be interpreted as having any dependency or requirement relating to any one or combination of components illustrated in the computer 200.

As shown in FIG. 2, components of the computer 200 include a processor 210 (the processor may be implemented by multiple processors instead of one processor), a system memory 220, and a bus 230 that couples various system components including the system memory 220 to the processor 210.

The bus 230 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus also known as Mezzanine bus.

The computer 200 typically includes a variety of computer readable media. Such media may be any available media that is accessible by computer 200, and it includes both volatile and non-volatile media, removable and non-removable media.

In FIG. 2, the system memory 220 includes computer readable media in the form of volatile memory, such as random access memory (RAM), and/or non-volatile memory, such as read only memory (ROM). A basic input/output system (BIOS), containing the basic routines that help to transfer information between elements within the computer 200, such as during start-up, is stored in the ROM. The RAM typically contains data and/or program modules that are immediately accessible to and/or presently being operated on by processor 210.

The computer 200 may further include other removable/non-removable, volatile/non-volatile computer storage media. For example, FIG. 2 illustrates a hard disk drive 240 for reading from and writing to a non-removable, non-volatile magnetic media (typically called a “hard drive”). The hard disk drive 240 and associated computer-readable media provide nonvolatile storage of computer readable instructions, data structures, program modules, and other data for the computer 200. Although the exemplary environment described herein employs a hard disk, it should be appreciated by those skilled in the art that other types of computer readable media which can store data that is accessible by a computer, such as removable magnetic disks, removable optical disks, magnetic cassettes, flash memory cards, digital video disks, random access memories (RAMs), read only memories (ROM), and the like, may also be used in the exemplary operating environment.

A number of program modules may be stored on the hard disk 240 or the system memory 220, including, e.g., an operating system (OS) 221, one or more application programs 226, a shared session event manager (SSEM) 222, a pop-up notification program (PNP) 223, a shared session identifier (SSI) 225, and a pop-up policy database (PPD) 227.

The SSEM 222, the PNP 223, the SSI 225, and the PPD 227 described herein, together or separately, may be implemented within operating system 221, or one or more application programs 226.

A user may input commands and information into the computer 200 through input devices such as a keyboard 292 and a pointing device 291 (such as a “mouse”). Other input devices (not shown) may include a microphone, joystick, game pad, satellite dish, serial port, scanner, camera, etc. These and other input devices are connected to the processing unit 210 through a user input interface 290 that is coupled to the bus 230, but may be connected by other interface and bus structures, such as a parallel port, game port, or a universal serial bus (USB).

A monitor 285 is also connected to bus 230 via an interface, such as a video adapter 260. The monitor 285 can also be connected to the computer 200 remotely via network connection. In addition to the monitor 285, personal computers typically include other peripheral output devices (not shown), such as speakers and printers, which may be connected through output peripheral interface.

When used in a LAN networking environment, the computer 200 is connected to a network via a network interface or adapter 280. When used in a WAN networking environment, the computer 200 typically includes a modem or other means for establishing communications over WAN. The Modem, which may be internal or external, may be connected to system bus 230 via the user input interface 290 or other appropriate mechanism.

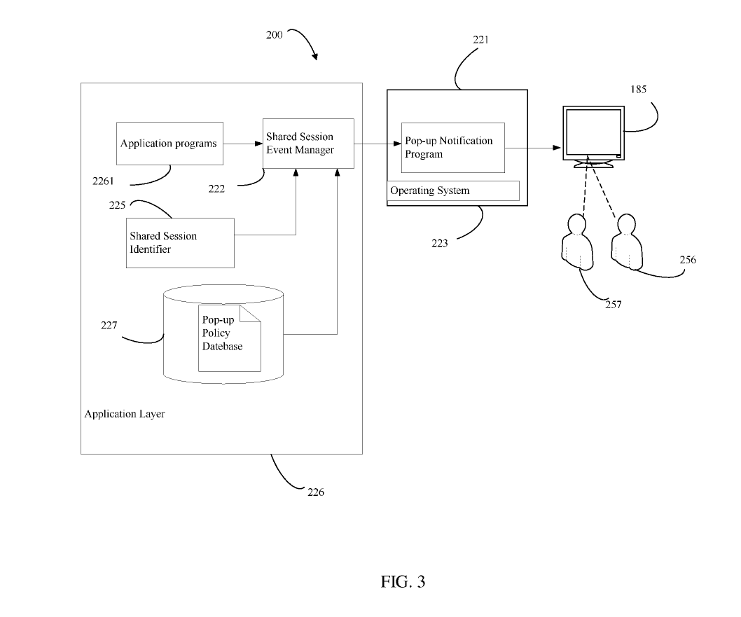

FIG. 3 illustrates an example of the computer 200 in another perspective on which the subsequently described methods and apparatuses may be implemented. As shown in FIG. 3, the OS 221 of the computer 200 includes the PNP 223 for generating pop-up notifications to be displayed graphically on the monitor 285. A pop-up notification could result from a user action or significant system event, or could offer potentially useful information from the OS 221 or the application program 226. Nowadays, many operating systems are configured with a PNP. In Microsoft Window 2000, Microsoft introduced balloon like passive pop-up notification, tied to the notification area of the task bar. Other operating systems, for example, Android system, etc., also are configured with a PNP for generating pop-up notifications. The PNP 223 can be part of the OS 221, or people skilled in the art would appreciate that the PNP 223 can be an application to be installed on the computer 200. Also, the monitor 285 can be part of the computer 200, or be a remote component connected to the computer 200 via network.

Application programs 226 installed in the computer 200 can send notification request to the PNP 223 to cause the PNP 223 to generate pop-up notifications. For example, an e-mail client, an Instant Messaging (IM) application, and other application programs may send a pop-up notification request to cause the PNP 223 to generate pop-up notifications when incoming messages are received. The e-mails client, also known as mail user agent (MUA), is a computer program used to access and manage a user's emails, e.g., Microsoft Outlook, IBM Lotus Notes, Pegasus Mail, Mozilla's Thunderbird, The Bat!, Eudora, etc. The Instant Messaging (IM) application is a type of online chat which offers real-time text transmission over the Internet, e.g., Skype, etc. Other application programs may also trigger pop-up notifications by sending pop-up notification requests to the PNP 223, or put it in another way, calling the PNP 223.

Pop-up notifications are displayed without the user's immediate approval or active operation, thus it may be displayed on the monitor 285 in an undesired timing. For example, when the user is in an online meeting and the user is sharing his screen with other users, information displayed on the monitor 285 may also be displayed on other monitors with their computers participating the online meeting. Thus, as shown in the embodiment of FIG. 2, the SSI 225, the SSEM 222, and the PPD 227 are introduced to manage display of pop-up notifications.

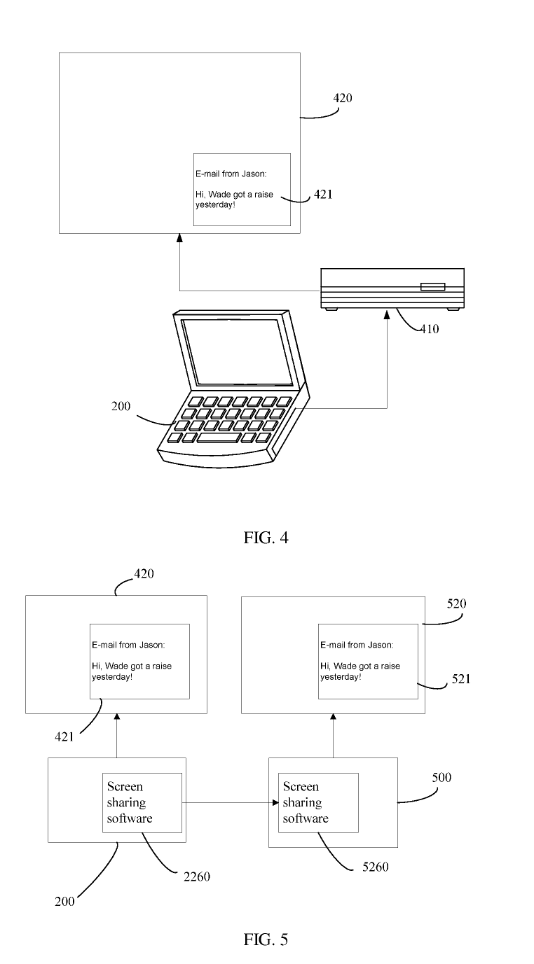

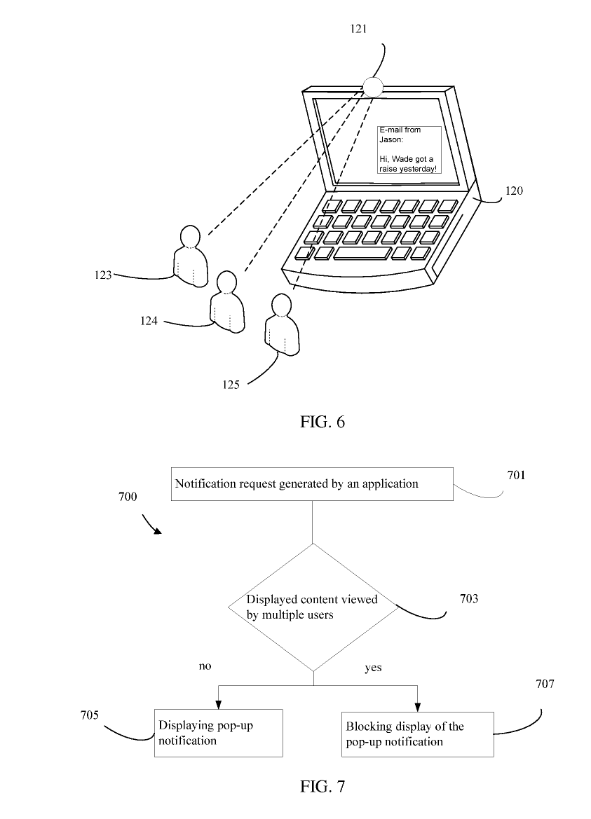

Referring to FIG. 3, the SSI 225 is configured to determine whether the computer 200 is in a shared session which displayed content of the computer 200 is viewed by multiple users. In order to determine whether displayed content of the computer 200 is viewed by multiple users, there typical examples considered as displayed content of the computer 200 is viewed by multiple users will be described herewith. For example, as shown in FIG. 4, the computer 200 is connected to a projector 410 which allows content displayed to the user being viewed by other users via a large screen 420. A pop-up notification 421 carrying a message pops up on displayed content of the computer 200 on the screen 420. In another example, as shown in FIG. 5, the computer 200 participates in an online conference and shares its screen with another computer 500 via a screen sharing software 550. In another scenario, as shown in FIG. 6, multiple users view the same monitor 285. To determine whether there are multiple users viewing the same monitor 285, the SSI 225 may employs a camera 121 and uses facial detection technologies (aka. facial recognition technologies) to determine whether there are multiple users appear in front of the monitor 285.

The PPD 227 stores pop-up notification display policies for managing pop-up notifications. One exemplary policy can simply be based on whether the displayed content of the computer 200 is being viewed by multiple users. As shown in Table 1, a first pop-up notification display policy instructs the computer 200 to block display of a pop-up notification when the displayed content of the computer 200 is determined to be being viewed by multiple users. Otherwise, if the displayed content of the computer 200 is not being viewed by multiple users, a pop-up notification should be displayed normally.

In an alternative example, when displayed content of the computer 200 is being viewed by multiple users, the first pop-up notification display policy may instruct the computer 200 to block display of the pop-up notification and queue the pop-up notifications (or events causing displaying of the pop-up notifications) and display them when the displayed content of the computer 200 is determined to be not being viewed by multiple users.

TABLE 1
The First Pop-up Notification Display Policy

| In a shared session | Action |
|---|---|
| Yes | Block |
| No | Display |

There is other pop-up notification display policies which may be made based upon the time the events causing pop-up notification occurs. For example, as shown in Table 2. A second pop-up notification display policy may instruct the computer 200 to block displaying of a pop-up notification when displayed content of the computer 200 is determined to be being viewed by multiple users and the events causing the pop-up notification occurs (detected) within working hours. The second pop-up notification display policies may queue the pop-up notification (or an event causing displaying of the pop-up notification) when displayed content of the computer 200 is determined to be viewable for multiple users and the event causes the pop-up notification occurs outside working hours. In case the displayed content of the computer 200 is not viewable for multiple users, a pop-up notification should be displayed regardless of whether an event occurs within working hours.

TABLE 2
The Second Pop-up Notification Display Policy

| In a shared session | Within working hours | Action |
|---|---|---|
| Yes | Yes | Block |
| | No | Queue |
| No | Yes | Display |
| | No | Display |

Alternatively, a pop-up notification display policy can also be made based upon geological location. As shown in Table 3. A third pop-up notification display policy may instruct the computer 200 to block displaying of a pop-up notification when the displayed content of the computer 200 is viewable for multiple users and the computer's location is in a pre-configured area. The third pop-up notification display policy may instruct the computer 200 to queue the pop-up notification (or an event causing displaying of the pop-up notification) when the displayed content of the computer 200 is viewable for multiple users and the computer 200 is not in a pre-configured area. Wherein, the pre-configured area may include office, home or some other areas pre-configured by the user.

TABLE 3
The Third Pop-up Notification Display Policy

| | The location of the computer is | |
|---|---|---|
| In a shared session | in a pre-configured area | Action |
| Yes | Yes | Block |
| | No | Queue |
| No | Yes | Display |
| | No | Display |

A pop-up notification display policy can be made based upon the application programs 226. As shown in Table 4. A fourth pop-up notification display policy may instruct the computer 200 to block displaying of a pop-up notification when the displayed content of the computer 200 is determined to be viewable for multiple users and the pop-up notification is initialed by an application program listed on a pre-configured list. For example, the pre-configured list may include Microsoft outlook, Skype, etc. The fourth pop-up notification display policy may instruct the computer 200 to queue the pop-up notification when the displayed content of the computer 200 determined to be viewable for multiple users and the pop-up notification is not initiated by an application listed on a pre-configured list.

TABLE 4
The Fourth Policy

| | Initiated by an application listed | |
|---|---|---|
| In a shared session | on a pre-configured list | Action |
| Yes | Yes | Block |
| | No | Queue |
| No | Yes | Display |
| | No | Display |

As an alternative example, a pop-up notification display policy may be made based on recognized users in front of the monitor 285. If users viewing the monitor 285 (in front of the monitor 285 and recognized by the camera installed on the monitor 285) are recognized as trusted users, the pop-up notification display policy may instruct the computer 200 to display pop-up notifications as usual. Otherwise, if at least one of the users recognized is determined to be a non-trusted user, the computer 200 may block or queue the pop-up notifications. The computer 200 may store trusted user profile images in its memory, and determine whether there is any non-trusted users viewing the monitor 285 by comparing recognized users to the pre-stored trusted user profile images.

The SSEM 222 implements pop-up notification management by enforcing a pop-up notification display policy obtained from the PPD 227. The SSEM 222 may block a pop-up notification requests for triggering a pop-up notification sent from the Application program 226 to the PNP 223 if an action indicated by an adopted pop-up notification display policy is to block displaying of the pop-up notification. In the case of queuing pop-up notifications, the SSEM 222 queues pop-up notification requests and forwards them to the PNP 223 when the displayed content of the computer 200 is no longer determined to be viewable for multiple users.

In order to implement the pop-up notifications management according to a pop-up notification display policy obtained from the PPD 227, the SSEM 222 may rely on the SSI 225 to determine whether displayed content of the computer 200 is viewable for multiple users. Since some of the pop-up notification display policy may also be made based upon time and/or geological location, the SSEM 222 may obtain time information and/or geological location information from the computer's timer, calendar, and Global Position System (GPS). Alternatively, the SSEM 222 may obtain this information by accepting the user's input.

In another example, the SSEM 222 may manage displaying of pop-up notifications by working on pop-notifications generated by the PNP 223 before they are displayed with displayed content of the computer 200 on the monitor 285. After pop-up notifications are generated, the SSEM 222 blocks the pop-up notifications from being displayed on the monitor 285, or queues the pop-up notifications and displays them when display content of the computer 200 is determined to be not viewable for multiple users.

As another example, the SSEM 222 may be implemented as part of the PNP 223, to queue or block pop-up notification(s) according to a pop-up notification display policy obtained from the PPD 227. The SSEM 222 can also be implemented as part of one of the application programs 226, to queue or block pop-up notification requests generated by the application program.

FIG. 7 is a logic flow diagram illustrating a method 700 for preventing sensitive information leaked by pop-up notifications. Throughout the following description of the method 700, reference will occasionally be made to the components shown on FIGS. 2-6.

In step 701, the computer 200 receives a notification request from an application programs 226 running on the computer. The notification request is intended to cause display of a pop-up notification.

The computer 200, to be more specifically, the SSI 225 of the computer 200 determines whether displayed content of the computer 200 is viewed by multiple users (step 703). In Step 705, if the displayed content is determined to be not being viewed by multiple users, the computer 200 displays pop-up notification normally. In the other hand, in step 707, if displayed content of the computer 200 is determined to be viewed by multiple users, the computer 200 blocks display of the pop-up notification caused by the notification request.

Instead of simply blocking display of the pop-up notification, the SSEM 222 of the computer 200 can apply pop-up notification display polices stored in the PPD 227 to manage display of pop-up notifications. Those policies will instruct the computer 200 to block display of pop-up notifications once certain conditions of the policies are met.

By blocking display of pop-up notifications or blocking display of pop-up notifications according to pre-configured pop-up notification display policy after displayed content of the computer is determined to be viewed by multiple users, pop-up notifications, especially pop-up notifications with sensitive content would not be leaked to a group of users viewing the displayed content.

The improved methods and apparatuses herein are operational with numerous other general purpose or special purpose computing system environments or configurations. Examples of well known computing systems, environments, and/or configurations that may be suitable include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like. Moreover, those skilled in the art will appreciate that the invention may be practiced with other computer system configurations, including hand-held devices, multi-processor systems, microprocessor based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

The steps of a method or algorithm described in connection with the embodiments disclosed herein may be embodied directly in hardware, in a software module executed by a processor, or in a combination of the two. A software module, e.g., the APPs 226, the SSEM 222, the PNP 223, the SSI 225, and the PPD 227 may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computer or a user terminal. In the alternative, the processor and the storage medium may reside as discrete components in a computer or user terminal.

The invention has been described in conjunction with various embodiments herein. However, other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems.

1. A method performed by a computer for managing display of pop-up notifications, the method comprising:
receiving a notification request, from an application running on the computer, for causing display of a pop-up notification;
determining that the computer is in a shared session via a screen share application to share displayed content of the computer with a remote computer;
based upon the determining that the computer is in the shared session, in response to the notification request, blocking display of the pop-up notification.

2-4. (canceled)

5. The method according to claim 1, the method further comprising:
queuing the notification request, or the pop-up notification caused by the notification request on a memory of the computer;
determining that displayed content of the computer is not viewed by multiple users; and
based upon the determining, displaying the pop-up notification.

6. The method according to claim 1, wherein blocking display of the pop-up notification comprises:
determining that the notification request occurs within or outside of working hours; and
blocking display of the pop-up notification.

7. The method according to claim 1, wherein blocking display of the pop-up notification comprises:
determining that the computer is located in a pre-configured area; and
blocking display of the pop-up notification.

8. A computer for managing pop-up notifications, comprising:
a memory configured to store instructions;
a processor configured to executed the stored instructions to:
receive a notification request for causing display of a pop-up notification from an application running on the computer;
determine that the computer is in a shared session via a screen share application to share displayed content of the computer with a remote computer;
based upon the determining that the computer is in the shared session, in response to notification request, block display of the pop-up notification.

9-11. (canceled)

12. The computer of claim 8, wherein the processor is further configured to executed the stored instruction to:
queue the notification request, or the pop-up notification caused by the notification request on a memory of the computer; and
determine that displayed content of the computer is not viewed by multiple users; and
based upon the determining, display the pop-up notification.

13. The computer of claim 8, wherein blocking display of the pop-up notification comprises:
determining that the notification request occurs within or outside of working hours; and
blocking display of the pop-up notification.

14. The computer of claim 8, wherein blocking display of the pop-up notification comprises:
determining that the computer is located in a pre-configured area; and
blocking display of the pop-up notification.
